(19) United States
(12) Patent Application Publication
(10) Pub. No.: US 2008/0102857 A1
(43) Pub. Date: May 1, 2008

(54) Method and apparatus for displaying map information

(75) Inventor: Sang Oh Kim, Siheong-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/656,502

(22) Filed: Jan. 23, 2007

(30) Foreign Application Priority Data
Jan. 23, 2006 (KR) 10-2006-0006712

(51) Int. Cl. H04Q 7/20

(52) U.S. Cl. 455/456.3

(57) ABSTRACT

A method for providing road guidance information includes displaying supplemental local area information in response to a prompt by a user on a map displayed for road guidance. In another method, the method includes receiving an information request for supplemental local area information, selecting supplemental local area information conforming to the information request among obtained local area information, and displaying the selected local area information on a map for road guidance. An apparatus for providing road guidance information includes a display device, a detector configured to detect a current location of the apparatus, a storage unit storing map data, and a controller configured to read out a region from the stored map data, and to display the region on the display device as a road guidance map. The controller further displays supplemental local area information on the road guidance map in response to an external request.

This application claims priority to the Korean Patent Application No. 10-2006-0006712, filed in Korea on Jan. 23, 2006, which is hereby incorporated by reference in its entirety.

### BACKGROUND OF THE INVENTION

1. Field of the Invention

The present invention relates generally to methods and apparatuses for displaying map information for road guidance, and more particularly to methods and apparatuses for displaying supplemental local area information requested by the user.

2. Description of Related Art

A navigation terminal is an apparatus intended for road guidance. The navigation terminal helps a user reach a destination, such as, a place new to him or appointed place of importance, without difficulty.

A navigation terminal utilizes GPS (Global Positioning System) signals to determine current location information (coordinate data) based on signals transmitted independently from low-orbit satellites for GPS. The navigation terminal displays a region centered around the current location from a pre-stored map database (electronic map or map data) on a screen. A driver (or user) can easily perceive road segments to navigate (or drive through) from a currently displayed region.

As shown in FIG. 1, a navigation terminal is equipped with a function to search for an optimal path leading to a destination set by the user and to display the path 11 on an electronic map. As shown in FIG. 2, also provided by the navigation terminal is a function for scaling a display at several levels to enhance perception of a driver. For example, as a display level selected by the user goes up from level 2 to level 10 as indicated by numeral 12, the scale of a displayed electronic map is decreased accordingly so that much finer roads may be displayed.

When the scaled display of an electronic map is carried out, screen display is permitted up to a level where recognition of characters associated with landmarks included already in the electronic map is not hindered. However, the displayed landmark information is very little, concerned only with salient landmarks or conventional objects such as buildings, roads, and public institutions. On the other hand, in addition to landmark information included in a current map, a driver may want to know local area information related with a region belonging to a current navigation path or outside of the current path. For instance, during road guidance to a destination, a driver may want to find a place or building assumed to be located at a current location (e.g., restaurant, theater, etc.) on a map. However, a navigation terminal as of present does not satisfy the needs of a driver as described above by providing supplemental local area information.

### BRIEF SUMMARY OF THE INVENTION

An aspect of the present invention provides supplemental local area information of a current location according to user request.

Another aspect of the present invention allows the user to obtain supplemental local area information of a current location by simple manipulation.

A further aspect of the present invention provides rich supplemental local area information while avoiding degradation in perceptibility of individual supplemental local area information displayed on a screen.

A method for providing road guidance in accordance with the present invention includes displaying supplemental local area information in response to a prompt by a user on a map displayed for road guidance.

Another method for providing road guidance in accordance with the present invention includes receiving an information request for supplemental local area information, selecting supplemental local area information conforming to the information request among obtained local area information, and displaying the selected local area information on a map for road guidance.

In accordance with another aspect of the present invention, the supplemental local area information may consists of a plurality of supplemental local area information filters, each filter thereof containing a categorized supplemental local area information group.

In accordance with a further aspect of the present invention, a selected supplemental local area information filter may replace a supplemental local area information filter displayed previously on the map.

In accordance with yet another aspect of the present invention, a selected supplemental local area information filter may be displayed being overlaid on a supplemental local area information filter displayed previously on the map.

In accordance with another aspect of the present invention, one from a plurality of supplemental local area information filters may be selected and displayed on the map.

In accordance with a further aspect of the present invention, a plurality of supplemental local area information filters may be displayed as being overlaid on the map at the same time.

In accordance with another aspect of the present invention, supplemental local area information having a character string conforming to a user input condition is displayed on the map.

In accordance with a further aspect of the present invention, the user input condition may be a code constituting a character.

In addition to the various methods method for providing road guidance, an apparatus for providing road guidance in accordance with the present invention includes a display device, a detector configured to detect a current location of the apparatus, a storage unit storing map data, and a controller configured to read out a region from the stored map data, the region being associated with the detected current, and to display the region on the display device as a road guidance map. The controller is further configured to display supplemental local area information on the road guidance map in response to an external request

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 illustrates a screen display for road guidance provided by a navigation terminal;

FIG. 2 illustrates an example where scale of a map is adjusted in various levels and a scaled map is displayed on a navigation screen;

FIG. 3 illustrates a block diagram of a navigation terminal in accordance with one embodiment of the present invention;

FIGS. 4a and 4b illustrate configurations of supplemental local area information in accordance with an embodiment of the present invention;

FIG. 5 illustrates a flow chart of one embodiment of a method for displaying map information in accordance with the present invention;

FIG. 6 illustrates an example where supplemental local area information is provided on a navigation screen in accordance with one embodiment of the present invention; and

FIGS. 7a and 7b illustrate examples where supplemental local area information consisting of a plurality of filters is displayed on a navigation map in accordance with an embodiment of the present invention.

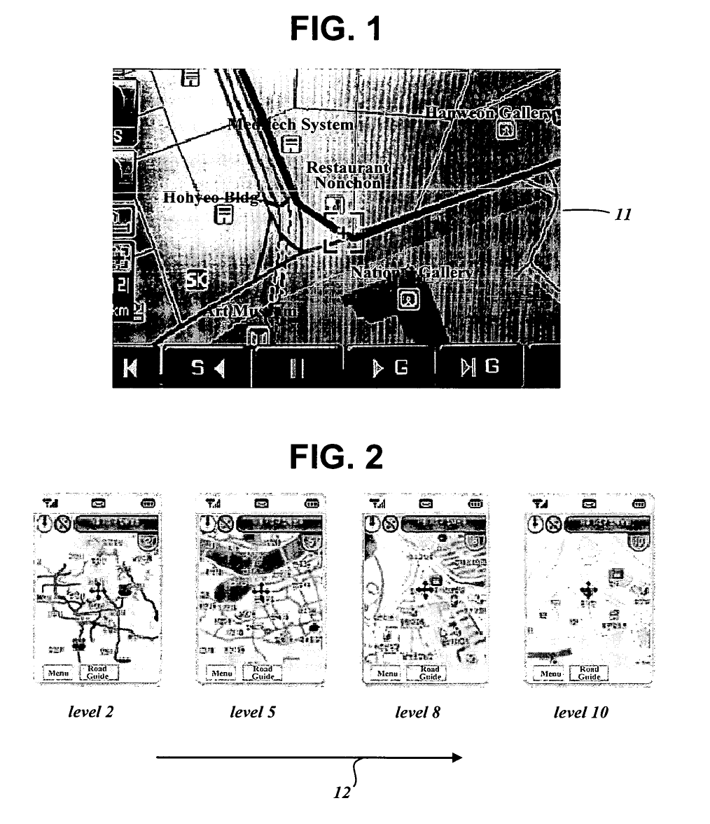

### DETAILED DESCRIPTION OF THE PREFERRED EMBODIMENTS

Hereinafter, according to the present invention, preferred embodiments will be described in detail with reference to appended drawings.

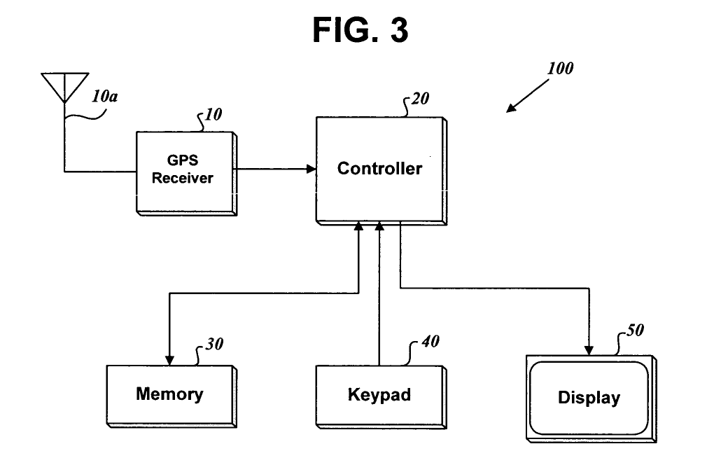

FIG. 3 illustrates a block diagram of a navigation terminal in accordance with one embodiment of the present invention.

As shown in FIG. 3, a navigation terminal 100 in accordance with one embodiment of the present invention comprises a GPS receiver 10, a control unit 20, a memory 30 storing an electronic map and various graphic information, a key input unit 40, and a display unit 50. The memory 30 has a capacity needed for building map database (electronic map or map data) and can be composed of flash ROM or EEPROM. Alternatively, an electronic map is recorded on a removable medium (e.g., optical recording medium such as CD or DVD) and a disk drive for reading out the map can be added as an element constituting a navigation terminal of FIG. 3. A storage means for storing an electronic map (memory 30 or optical recording medium) also stores supplemental local area information configured in accordance with the present invention.

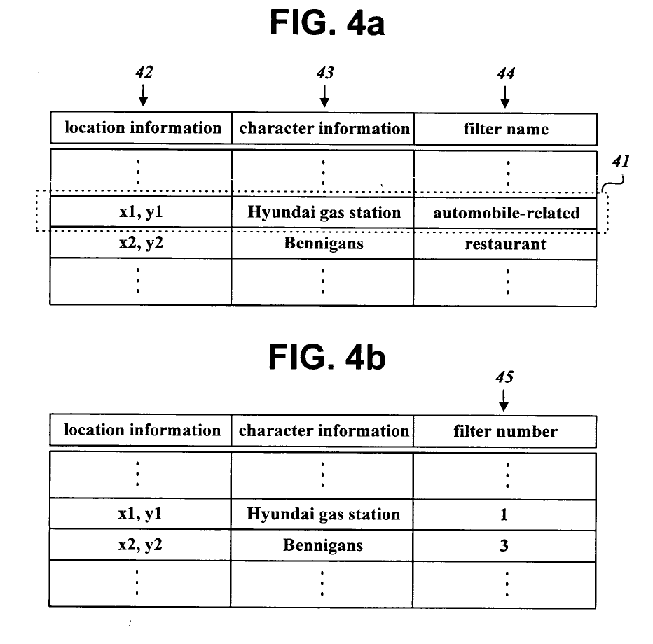

FIG. 4a illustrates a configuration of supplemental local area information (or neighboring area information) in accordance with one embodiment of the present invention. An entry 41 of supplemental local area information includes location information 42 for displaying a particular place at the corresponding position on an electronic map (e.g., longitude and latitude information or relative location information with respect to a particular reference point), character information 43 for display, and a name of a filter 44 where the entry belongs. In addition, an entry can contain information about an icon to be displayed along with character information. Since the fact that supplemental local area information may include other elements that are not mentioned in the description of the present invention has no relevance to the spirit and scope of the present invention, omission of description on the other elements does not limit the accomplishment of the present invention.
FIG. 4b illustrates an alternative configuration of supplemental local area information in accordance with another embodiment of the present invention. This embodiment includes a filter number 45 instead of a filter name in order to indicate a filter where an entry of supplemental local area information belongs.

For the foregoing embodiments, supplemental local area information may be composed of multiple filters. For example, where supplemental local area information is categorized into groups, elements of respective groups can be distributed across multiple filters. Alternatively, a single filter can comprise the entire supplemental local area information.

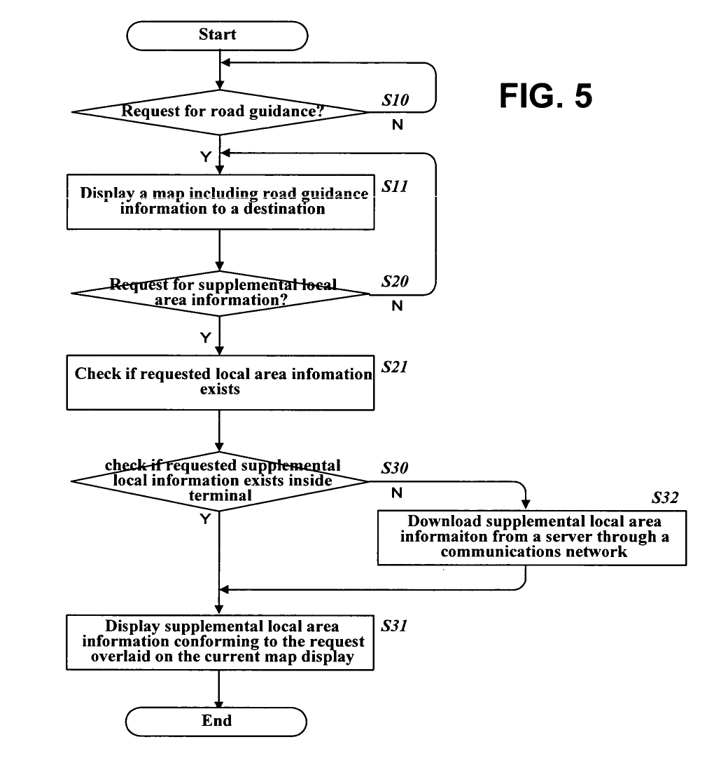

FIG. 5 illustrates a flow chart of one embodiment of a method for displaying map information in accordance with the present invention. The flow chart of FIG. 5 is described in detail along with display operations of map information in accordance with the present invention, display operations being carried out by the apparatus of FIG. 3.

The GPS receiver 10 receives signals transmitted from multiple satellites through a GPS antenna 10a, calculates information about a current location, i.e., longitude, latitude, and altitude information (coordinate information), and provides the location information to the control unit 20.

Having identified the location, when the user (or driver) enters a destination by using the key input unit 40, thereby issuing a request for road guidance S10, the control unit 20, based on the received location information, determines current location of the user (or a car), reads a local electronic map of a region centered around current location from an electronic map of the memory 30, and feeds the local electronic map to the display unit 50 for display S11. The extent of the local map displayed on a screen is determined based on a current map scale and screen resolution. The control unit 40 also searches for an optimal path from the current location to the destination and makes road segments comprising the optimal path have a different color from the others for easy identification. By using road guidance information on an electronic map as described above, the user (or driver) can easily move to a destination.

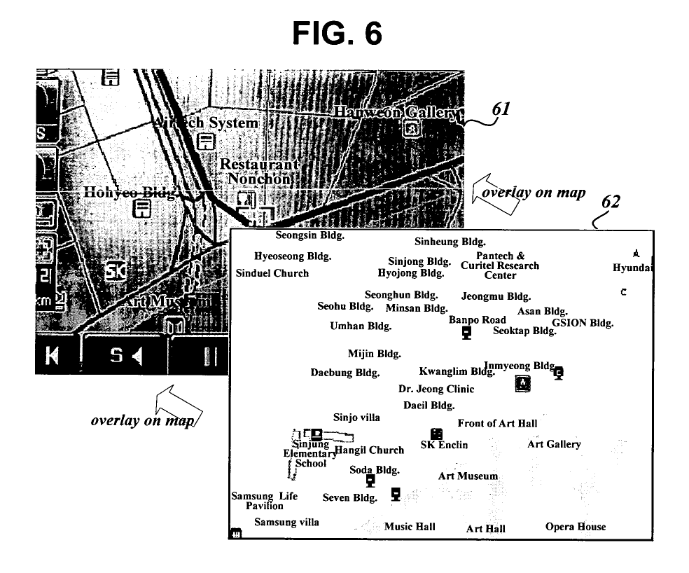

While moving (or driving) to the destination, when the user requests display of supplemental local area information by using the key input unit 40 in order to find a nearby region or a place (e.g., to find a nearby convenience store or a gas station) S20, the control unit 20 checks whether supplemental local area information conforming to the information request exists S30. If the supplemental local area information exists, the control unit controls the display unit 50 so that supplemental local area information 62 belonging to a filter (or filters) relevant to the request is overlaid on a currently displayed navigation map 61, as illustrated in FIG. 6. The navigation map 61 also includes the previously displayed map data overlaid with a layer of topography and conventional objects and a layer with a determined path S31.

On the other hand, when a supplemental local area information filter or a selected supplemental local area information filter does not exist, the control unit 20 connects to a communications network (e.g., to a designated server through wireless mobile communications network when the navigation terminal 100 is equipped with a wireless communications module), downloads a selected supplemental filter or all supplemental local area information filters S32, and stores the filter(s) in the memory 30, the filter(s) being displayed on a screen through the display unit 50. For this purpose, the navigation terminal 100 stores information needed to connect to the designated server in the memory 30.

The request for supplemental local area information may correspond to a name of a supplemental local area information filter, as illustrated in FIG. 4a, or the request becomes a filter number of supplemental local area information, as illustrated in FIG. 4b. When a supplemental local area information filter consists of a single filter, the single supplemental local area information filter is readily selected and displayed in response to ‘local information’ key input instead of selection of a supplemental local area information filter. Input of a filter name or filter number adopts an input procedure that utilizes as small number of keys as possible for the key input unit 40. For example, when ‘local information’ key is pressed, a list of filter names or filter numbers is displayed and one from among the list is selected by using a key that moves up and down or left and right.

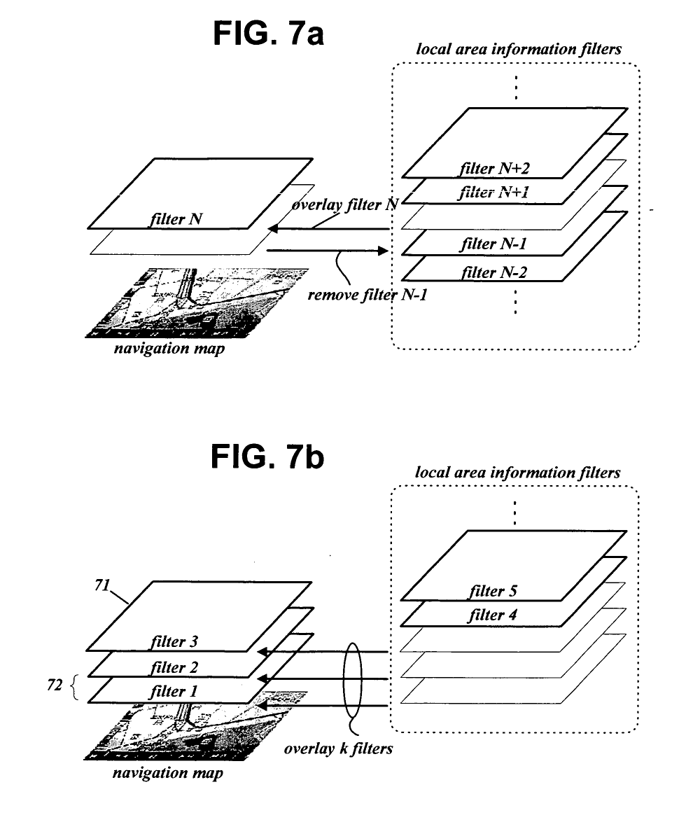

In another embodiment in accordance with the present invention, an input key of ‘local information’ is prepared in the key input unit 40. Each time the user presses the key, as illustrated in FIG. 7a, a supplemental local area information filter is selected sequentially and displayed on the display unit 50, replacing a previously displayed supplemental local area information filter.

In a yet another embodiment in accordance with the present invention, each time the user presses the key of ‘local information’, as illustrated in FIG. 7b, a supplemental local area information filter is selected sequentially and a currently selected supplemental local area information filter 71 is displayed on the display unit 50, being overlaid with supplemental local area information of a previously selected filter 72.

In embodiments described above, each supplemental local area information filter can have a unique name, representing a property of supplemental local area information contained in the corresponding filter. For example, a filter containing supplemental local area information about nearby restaurants can have a name of ‘restaurant’. When a supplemental local area information filter is displayed being overlaid on the display unit 50, the control unit 20 makes a name assigned to the filter displayed at a particular position in a screen.

In another embodiment in accordance with the present invention, even when the memory 30 is equipped with supplemental local area information composed of multiple filters, if the user enters a predefined key input or a particular key in a specific way (i.e., the case when ‘local information’ key is pressed longer than a threshold), all of supplemental local area information filters are displayed overlaid on the display unit 50 at the same time.

In another embodiment in accordance with the present invention, while a supplemental local area information filter being displayed overlaid on a screen through the procedure described above, a part of the displayed supplemental local area information (supplemental local area information belonging to a supplemental local area information filter occupying a highest or last overlaid layer) is selectively displayed. For example, when the user enters a character code ‘a’ through a suitable input procedure (e.g., by using keys of the key input unit 40 or by using a menu screen provided by the display unit 50), supplemental local area information beginning with a letter ‘a’ is retained, while the other supplemental local area information is removed from the display unit 50. Subsequently, when the user enters a character code ‘b’, from among supplemental local area information beginning with a letter ‘a’, supplemental local area information beginning with ‘ab’ is retained, the other supplemental local area information being removed accordingly. By following the same procedure afterwards, supplemental local area information of displayed filters is processed so that only the supplemental local area information that the user has a partial knowledge is retained on a screen. According to the present embodiment, even when the user has only a partial knowledge, an object in question can be found more easily and quickly as a result of the reduced amount of displayed supplemental local area information.

In another embodiment in accordance with the present invention, while more than one supplemental local area information filter being displayed on a screen, when the user enters an arbitrary character code, supplemental local area information beginning with the character code throughout a filter at the topmost position and all the remaining filters below is retained, other supplemental local area information being removed. Character codes entered sequentially afterwards are processed in the same way as described above.

In another embodiment in accordance with the present invention, even when a supplemental local area information filter is not displayed on the display unit 50, if the user enters an arbitrary character code, all filters beginning with the character code stored in memory 30 are displayed overlaid on the display unit 50. Character codes entered sequentially afterwards are processed in the same way as described above.

According to an embodiment described above, when one or more supplemental local area information filters is displayed overlaid on a map and the user enters a particular key in the key input unit 40 (e.g., a key named as ‘map’), the control unit 20 makes all the supplemental local area information filters disappear from the display unit 50.

Embodiments described above can equally be applied to a road guidance function supplied to a portable terminal used for finding a route on foot as well as a car navigation terminal installed on a car.

The present invention described in detail through a limited number of embodiments above helps the user (or driver) find a supplemental local area or place in question quickly and easily without the user looking or wandering around a supplemental local area during movement to a destination, thus enhancing convenience for the user.

The foregoing description of the preferred embodiments of the present invention has been presented for purposes of illustration. Thus, those skilled in the art may utilize the invention and various embodiments with improvements, modifications, substitutions, or additions within the spirit and scope of the invention as defined by the following appended claims.

What is claimed:

1. A method for providing road guidance information, the method comprising:
displaying supplemental local area information in response to a prompt by a user on a map displayed for road guidance.

2. The method of claim 1, wherein the displaying supplemental local area information includes:
selecting one of a plurality of supplemental local area information filters; and
displaying the one supplemental local area information filter on the map display.

3. The method of claim 2, wherein the displaying supplemental local area information includes:
selecting a second of the plurality of supplemental local area information filters; and
replacing the one supplemental local area information filter displayed previously on the map with the second local area information filter is displayed instead thereof.

4. The method of claim 2, wherein the displaying supplemental local area information includes:
selecting a second of the plurality of supplemental local area information filters; and
overlaying the second of the plurality of supplemental local area information filters on the one local area information filter displayed previously on the map.

5. The method of claim 2, wherein the plurality of supplemental local area information filters contain categorized local area information differentiated from each other.

6. The method of claim 1, wherein the displaying supplemental local area information includes:
overlaying a plurality of supplemental local area information filters on the map display.

7. The method of claim 1, wherein the displaying supplemental local area information includes:
receiving the supplemental local area information from a remote place through a network.

8. The method of claim 1, further comprising:
inputing a condition for the supplemental local area information; and
removing supplemental local area information not conforming to the input condition from the displayed supplemental local area information.

9. The method of claim 8, wherein the input condition is a code constituting a character, and removing supplemental local area information includes:
comparing the code to character strings for the supplemental local area information and removing the supplemental local area information when the character string is not in the same placement order as the input code.

10. The method of claim 1, wherein a path for road guidance is displayed on the map.

11. The method of claim 1, further comprising:
detecting a current location of the user; and
displaying objects on the map display including at least roads.

12. A method for providing road guidance information, comprising:
receiving an information request for supplemental local area information;
selecting supplemental local area information conforming to the information request among obtained local area information; and
displaying the selected supplemental local area information on a map for road guidance.

13. The method of claim 12, wherein the selected supplemental local area information is selected from a plurality of local area information filters.

14. The method of claim 12, wherein the information request is a code constituting a character, and selecting supplemental local area information includes:
comparing the code to character strings for the supplemental local area information; and
returning the supplemental local information when the character string is in the same placement order as the input code.

15. The method of claim 14, further comprising:
detecting a current location of the user; and
displaying objects on the map display including at least roads.

16. An apparatus for providing road guidance information comprising:
a display device;
a detector configured to detect a current location of the apparatus;
a storage unit storing map data; and
a controller configured to read out a region from the stored map data, the region being associated with the detected current, and to display the region on the display device as a road guidance map,
the controller further configured to display supplemental local area information on the road guidance map in response to an external request.

17. The apparatus of claim 16, wherein the supplemental local area information is either stored in the apparatus or obtained from an external device via a network.

18. The apparatus of claim 16, wherein the controller, based on the map data, is configured to search for a path to reach a destination designated by a user and to display the path found from the search on the road guidance map displayed on the display device.

19. The apparatus of claim 16, wherein the displayed supplemental local area information belongs to at least one of a plurality of supplemental local area information filters.

20. The apparatus of claim 16, wherein the displayed supplemental local area information is selected information conforming to an information request for supplemental local area information.

21. The apparatus of claim 20, wherein the information request is a code constituting a character, and the supplemental local area information is selected information where a character string for the supplemental local area information is in the same placement order as the input code.

22. The apparatus of claim 16, wherein the road guidance map displays objects including at least roads.
